(19) United States
(12) Patent Application Publication
(10) Pub. No.: US 2025/0165577 A1
(43) Pub. Date: May 22, 2025

(54) EVENT-BASED GENERATION OF DELTA CERTIFICATES FOR IHS VALIDATION

(71) Applicant: Dell Products L.P., Round Rock, TX (US)

(72) Inventors: Vineeth Radhakrishnan, Palakkad (IN); Dharma Bhushan Ramaiah, Bangalore (IN); Shinose Abdul Rahiman, Bangalore (IN); Rama Rao Bisa, Bangalore (IN); Mini Thottunkal Thankappan, Bangalore (IN); A Anis Ahmed, Bangalore (IN); Jason Matthew Young, Round Rock, TX (US)

(73) Assignee: Dell Products L.P., Round Rock, TX (US)

(21) Appl. No.: 18/515,662

(22) Filed: Nov. 21, 2023

(51) Int. Cl. G06F 21/33; G06F 8/65; G06F 21/44

(52) U.S. Cl. CPC G06F 21/33; G06F 8/65; G06F 21/44

(57) ABSTRACT

Systems and methods are provided for event-based generation of delta certificates for validation of modifications to IHSs (Information Handling Systems), such as rack-mounted servers. During factory provisioning of the IHS, a factory-signed inventory certificate is uploaded to the IHS that identifies factory-installed hardware of the IHS and that also specifies cryptographic identification that are available for any these factory-installed hardware components. This inventory certificate is used to validate that the detected hardware of the IHS is genuine factory-installed hardware. Once validated, a remote access controller of the IHS initiates monitoring for cryptographic events that affect the ability to validate any of the factory-installed hardware. Upon detecting a cryptographic event, the remote access controller generates a delta certificate for validating components affected by the cryptographic event.

### FIELD

The present disclosure relates generally to Information Handling Systems (IHSs) and relates more particularly to supporting secure modifications to IHSs.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise-class servers that are stacked and installed within racks. A data center may include large numbers of such racks that may be organized into rows, where the servers installed in each rack may be outwardly very similar looking, such that it may be difficult for administrators to effectively keep track of the configurations and capabilities of any individual server in the data center. Moreover, administration of such large groups of servers may require teams of remote and local administrators working in shifts in order to support around-the-clock availability of the data center operations, while also minimizing any downtime. Each server IHS within a data center may support a wide variety of possible hardware and software configurations. For instance, each individual server IHS may be manufactured according to customized hardware and software configurations requested by a customer. Once an IHS has been received and deployed, a customer may make modifications to the hardware and software of the IHS in order to adapt it for a particular computing task or a particular physical environment.

### SUMMARY

In various embodiments, systems and methods include an IHS (Information Handling System) that include: one or more processors; one or more memory devices coupled to the processors, the memory devices storing computer-readable instructions that, upon execution by the processors, cause a validation process of the IHS to: validate hardware detected by the IHS as factory-installed based on an inventory specified in a first factory-provisioned inventory certificate; and notify a remote access controller when the hardware detected by the IHS is validated as factory-installed based on the inventory certificate; and the remote access controller comprising one or more logic units and further comprising one or more memory devices storing computer-readable instructions that, upon execution by the logic units, cause the remote access controller to: based on the notification of validated hardware from the IHS, initiate monitoring for cryptographic events related to the validated hardware; and when a cryptographic event is detected, generate a delta certificate for validating a first of the factory-installed hardware components of the IHS using updated cryptographic information from the detected cryptographic event.

In some embodiments, the cryptographic event comprises an update to a cryptographic attestation for the first of the factory-installed hardware components. In some embodiments, the cryptographic event comprises an update to a device identity certificate of the first of the factory-installed hardware components. In some embodiments, the cryptographic event comprises installation of an unrecognized hardware component to the IHS, where the unrecognized hardware component comprises a device identity certificate. In some embodiments, the cryptographic event comprises an update to firmware used by the first of the factory-installed hardware components. In some embodiments, the update to the firmware enables a cryptographic capability of the first of the factory-installed hardware components. In some embodiments, the enabled cryptographic capability comprises enabling use of a device identity certificate. In some embodiments, the factory-provisioned inventory certificate is stored to a persistent memory of the IHS during the factory-provisioning of the IHS. In some embodiments, the delta certificate is stored to the persistent memory of the IHS. In some embodiments, the monitoring for cryptographic events is not initiated by the remote access controller until receiving the notification that the hardware detected by the IHS is validated as factory-installed.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a diagram illustrating certain components of a chassis, according to some embodiments, for supporting event-based generation of delta certificates for validation of IHSs installed in the chassis.

FIG. 2 is a diagram illustrating certain components of an IHS configured, according to some embodiments, for supporting event-based generation of delta certificates for validation of the IHS.

FIG. 3 is a swim lane diagram illustrating certain responsibilities of components of a system configured according to certain embodiments for factory provisioning of an IHS in a manner that supports event-based generation of delta certificates for validation of the IHS.

FIG. 4A is a flowchart describing certain steps of a method, according to some embodiments, for assembly and provisioning of an IHS in a manner that supports event-based generation of delta certificates for validation of the IHS.

FIG. 4B is a flowchart that is a continuation of FIG. 4A.

FIG. 5 is a swim lane diagram illustrating certain responsibilities of components of a system configured according to certain embodiments for event-based generation of delta certificates for validation of an IHS.

FIG. 6A is a flowchart describing certain steps of a method, according to some embodiments, for validating the movement of shared chassis hardware components that are utilized by an IHS.

FIG. 6B is a flowchart that is a continuation of FIG. 6A.

FIG. 7 is a swim lane diagram illustrating certain responsibilities of components of a system configured according to certain embodiments for event-based generation of delta certificates for validation of an IHS.

### DETAILED DESCRIPTION

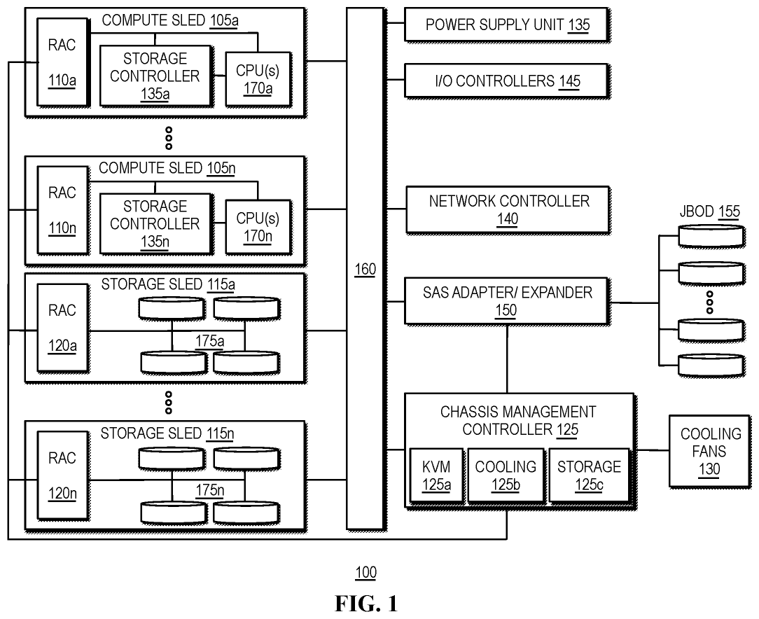

FIG. 1 is a block diagram illustrating certain components of a chassis 100 comprising one or more compute sleds 105a-n and one or more storage sleds 115a-n that may be configured to implement the systems and methods described herein for event-based generation of delta certificates for use in validation of IHSs that are installed in the chassis 100. Embodiments of chassis 100 may include a wide variety of different hardware configurations. Such variations in hardware configuration may result from chassis 100 being factory assembled to include components specified by a customer that has contracted for manufacture and delivery of chassis 100. Upon delivery of a chassis 100, the chassis and/or individual IHS sleds installed in the chassis 100, may be modified by replacing various hardware components or by installing new hardware components.

As described in additional detail below, chassis 100 may include capabilities that allow a customer to validate that hardware detected in chassis 100 is the same factory installed and provisioned hardware that was supplied to the customer. In addition, embodiments support secure modifications to chassis 100, such as by a designated administrator that receives the IHS from the manufacturer and may perform hardware customizations to support the requirements of a specific deployment. Over time, administrators may continue to perform customizations to the hardware of chassis 100. These modifications may be validated as authentic through the use of delta certificates that augment a factory-provisioned inventory certificate that specifies the factory-installed hardware of an IHS. In embodiments, the generation of delta certificates for use in validating the IHS may be initiated based on the detection of specific cryptographic events that are generated based on administration of the IHS.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

Multiple chassis 100 may be housed within a rack. Data centers may utilize large numbers of racks, with various different types of chassis installed in the various configurations of racks. The modular architecture provided by the sleds, chassis and rack allow for certain resources, such as cooling, power and network bandwidth, to be shared by the compute sleds 105a-n and storage sleds 115a-n, thus providing efficiency improvements and supporting greater computational loads. In some instances, these shared resources of chassis 100 are implemented through hardware components of chassis 100 that are shared by multiple of the compute sleds 105a-n and storage sleds 115a-n installed in the chassis.

Chassis 100 may be installed within a rack structure that provides all or part of the cooling utilized by chassis 100. For airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air from within the sleds 105a-n, 115a-n installed within the chassis. A rack and a chassis 100 installed within the rack may utilize various configurations and combinations of cooling fans to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160. In various embodiments, backplane 160 may include various additional components, such as cables, wires, midplanes, backplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140 and power supply unit 135. In some embodiments, a backplane 160 may be uniquely identified based on a code or other identifier that may be permanently encoded in a non-volatile memory of the backplane 160 by its manufacturer. As described below, embodiments may support validation of backplane 160 as being the same backplane that was installed at the factory during the manufacture of chassis 100. In some instances, backplane 160 may be confirmed as the factory-installed hardware based on attestations provided by the backplane 160 itself, such as a device certificate supported by the manufacturer of the backplane. Embodiments further support secure validation of modifications to the backplane 160, where the validation is supported by a delta certificate that is generated based on detection of a cryptographic event related to the backplane 160, such as a modification to the attestations used to validate the identity of the backplane.

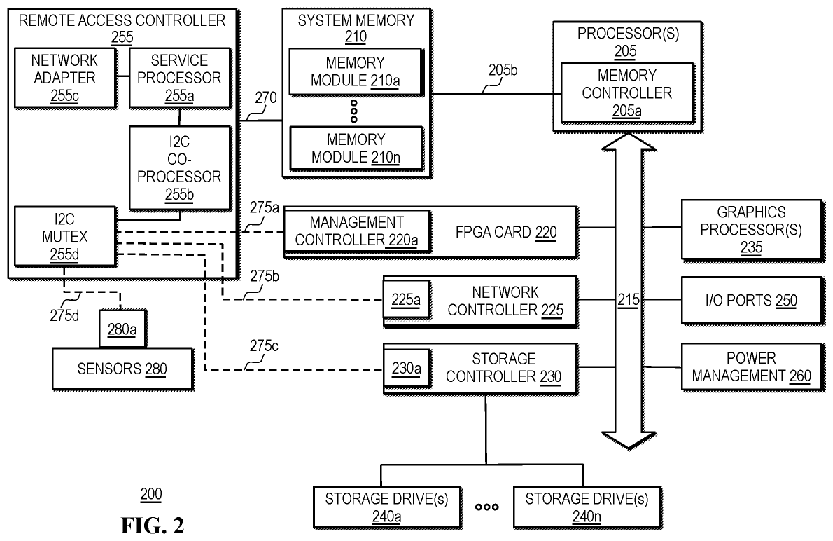

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n are typically configured with hardware and software that provide leading-edge computational capabilities. Accordingly, services provided using such computing capabilities are typically provided as high-availability systems that operate with minimum downtime. As described in additional detail with regard to FIG. 2, compute sleds 105a-n may be configured for general-purpose computing or may be optimized for specific computing tasks.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band and sideband (i.e., out-of-band) communications with various components of a compute sled 105a-n and chassis 100. Remote access controllers 110a-n may collect various types of sensor data, such as collecting temperature sensor readings that are used in support of airflow cooling of the chassis 100 and the sleds 105a-n, 115a-n. In addition, each remote access controller 110a-n may implement various monitoring and administrative functions related to compute sleds 105a-n that utilize sideband bus connections with various internal components of the respective compute sleds 105a-n.

In some embodiments, each compute sled 105a-n installed in chassis 100 may be uniquely identified based on a code or other identifier that may be permanently encoded in a non-volatile memory of a respective compute sled 105a-n by its manufacturer. In some embodiments, compute sleds 105a-n may each be identified based on attestations supported by each individual compute sled, such as a device identity certificate generated and supported by a manufacturer of the compute sled. As described below, during a provisioning phase of the factory assembly of chassis 100, a signed certificate that specifies hardware components of chassis 100, such as through such identifiers of compute sleds 105a-n, that were installed during its manufacture may be stored in a non-volatile memory accessed by a remote access controller 110a-n of a compute sled 105a-n. Using this signed inventory certificate, a customer may validate that the hardware components of chassis 100 are the same components that were installed at the factory during its manufacture. As described in additional detail below, embodiments may further support secure validation of the replacement, removal or addition of individual compute sleds 105a-n.

Each of the compute sleds 105a-n may include a storage controller 135a-n that may be utilized to access storage drives that are accessible via chassis 100. Some of the individual storage controllers 135a-n may provide support for RAID (Redundant Array of Independent Disks) configurations of logical and physical storage drives, such as storage drives provided by storage sleds 115a-n. In some embodiments, some or all of the individual storage controllers 135a-n may be HBAs (Host Bus Adapters) that provide more limited capabilities in accessing physical storage drives provided via storage sleds 115a-n and/or via SAS expander 150.

In addition to the data storage capabilities provided by storage sleds 115a-n, chassis 100 may provide access to other shared storage resources that may be installed components of chassis 100 and/or may be installed elsewhere within a rack housing the chassis 100, such as within a storage blade. In certain scenarios, such shared storage resources 155 may be accessed via a shared SAS expander 150 that is coupled to the backplane 160 of the chassis 100. The SAS expander 150 may support connections to a number of shared JBOD (Just a Bunch Of Disks) storage drives 155 that may be configured and managed individually and without implementing data redundancy across the various drives 155. The additional shared storage resources 155 may also be at various other locations within a datacenter in which chassis 100 is installed. Such additional shared storage resources 155 may also be remotely located. In some embodiments, a SAS expander 150 and storage drives 155 may be uniquely identified based on a code or other identifier that may be permanently encoded in a non-volatile memory of the SAS expander 150 or storage drive 155 by its respective manufacturer. In some embodiments, each of these storage drives 155 may be replaceable hardware components that are each be identified based on attestations supported by each individual storage drive 155, such as device identity certificates that are generated and supported by a manufacturer of the storage drive. In instances where SAS expander 150 and storage drives 155 are factory installed, as described below, embodiments may support validation of SAS expander 150 and storage drives 155 as being the same SAS expander and storage drives that were installed at the factory during the manufacture of chassis 100.

As illustrated, chassis 100 also includes one or more storage sleds 115a-n that are coupled to the backplane 160 and installed within one or more bays of chassis 200 in a similar manner to compute sleds 105a-n. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. The storage sleds 115a-n may be utilized in various storage configurations by the compute sleds 105a-n that are coupled to chassis 100. As illustrated, each storage sled 115a-n includes a remote access controller (RAC) 120a-n provides capabilities for remote monitoring and management of respective storage sleds 115a-n. In some embodiments, each storage sled 115a-n may be uniquely identified based on a code or other identifier that may be permanently encoded in a non-volatile memory of the respective storage sled 115a-n by its manufacturer. In some embodiments, storage sleds 115a-n may each be identified based on attestations supported by each individual storage sled, such as based on a device identity certificate that is generated and supported by a manufacturer of the storage sled. As described below, embodiments support validation of each storage sled 115a-n as being a storage sled that was installed at the factory during the manufacture of chassis 100.

As illustrated, the chassis 100 of FIG. 1 includes a shared network controller 145 that provides network access to the sleds 105a-n, 115a-n installed within the chassis. Network controller 145 may include various switches, adapters, controllers and couplings used to connect chassis 100 to a network, either directly or via additional networking components and connections provided via a rack in which chassis 100 is installed. Each of the IHSs (e.g., compute sleds 105a-n and storage sleds 115a-n) installed in chassis 100 may utilize network bandwidth provided by shared network controller 145. In some embodiments, a network controller 145 may be uniquely identified based on a code or other identifier that may be permanently encoded in a non-volatile memory of the network controller 145 by its manufacturer. In some embodiments, each a network controller 145 may be a replaceable hardware component that is identified based on attestations supported by an individual network controller 145, such as a device identity certificate that is generated and supported by a manufacturer of the network controller. As described below, embodiments support validation of network controller 145 as being the same network controller that was installed at the factory during the manufacture of chassis 100.

Chassis 100 may similarly include one or more shared power supply units 135 that provides the components of the chassis with various levels of DC power from an AC power source or from power delivered via a power system provided by a rack within which chassis 100 may be installed. In certain embodiments, power supply unit 135 may be implemented within a shared sled that may provide chassis 100 with multiple redundant, hot-swappable power supply units. Each of the IHSs (e.g., compute sleds 105a-n and storage sleds 115a-n) installed in chassis 100 may utilize power provided by shared power supply units 135. In some embodiments, a power supply unit 135 may be uniquely identified based on a code or other identifier that may be permanently encoded in a non-volatile memory of the power supply unit 135 by its manufacturer. In some embodiments, each a power supply unit 135 may be a replaceable hardware component that is identified based on attestations supported by an individual power supply unit 135, such as a device identity certificate that is generated and supported by a manufacturer of the power supply unit. As described below, embodiments support validation of power supply unit 135 as being the same power supply unit that was installed at the factory during the manufacture of chassis 100.

Chassis 100 may also include various shared I/O controllers 140 that may support various shared I/O ports, such as shared USB ports that may be used to support keyboard and mouse inputs and/or video display capabilities. Such shared I/O controllers 145 may be utilized by the chassis management controller 125 to support various KVM (Keyboard, Video and Mouse) 125a capabilities that provide administrators with the ability to interface with the chassis 100. In some embodiments, each I/O controller 140 may be uniquely identified based on a code or other identifier that may be permanently encoded in a non-volatile memory of the respective I/O controller 140 by its manufacturer. In some embodiments, each I/O controller 140 may be identified based on attestations supported by an individual I/O controller 140, such as a device identity certificate that is generated and supported by a manufacturer of the I/O controller. As described below, embodiments support validation of I/O controllers 140 as being the same I/O controllers that were installed at the factory during the manufacture of chassis 100.

The chassis management controller 125 may also include a storage module 125c that provides capabilities for managing and configuring certain aspects of the storage devices of chassis 100, such as the storage devices provided within storage sleds 115a-n and within the JBOD 155. In some embodiments, a chassis management controller 125 may be uniquely identified based on a code or other identifier that may be permanently encoded in a non-volatile memory of the chassis management controller 125 by its manufacturer. As described below, embodiments support validation of chassis management controller 125 as being the same chassis management controller that was installed at the factory during the manufacture of chassis 100.

In addition to providing support for KVM 125a capabilities for administering chassis 100, chassis management controller 125 may support various additional functions for sharing the infrastructure resources of chassis 100. In some scenarios, chassis management controller 125 may implement tools for managing the shared power 135, network bandwidth 140 and airflow cooling 130 that are available via the chassis 100. As described, the airflow cooling 130 utilized by chassis 100 may include a shared airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein for supporting event-based generation of delta certificates for validation of the IHS 200. It should be appreciated that although the embodiments described herein may describe an IHS that is a compute sled or similar computing component that may be deployed within the bays of a chassis, other embodiments may be utilized with other types of IHSs that may also support validation of the secure assembly and delivery of the IHS 200, where such validations may be conducted using delta certificates that are generated in response to cryptographic events that are detected during the administration of the IHS. In the illustrative embodiment of FIG. 2, IHS 200 may be a computing component, such as compute sled 105a-n or other type of server, such as an 1RU server installed within a 2RU chassis, that is configured to share infrastructure resources provided by a chassis 100.

As described, an IHS 200 may be assembled and provisioned according to customized specifications provided by a customer. The IHS 200 of FIG. 2 may be a compute sled, such as compute sleds 105a-n of FIG. 1, that may be installed within a chassis, that may in turn be installed within a rack. Installed in this manner, IHS 200 may utilize shared resources, such as power 135, network 140 and cooling 130 resources, provided by the chassis 100. Embodiments of IHS 200 may include a wide variety of different hardware configurations. Such variations in hardware configuration may result from IHS 200 being factory assembled to include components specified by a customer that has contracted for manufacture and delivery of IHS 200. As described in additional detail below, IHS 200 may include capabilities that allow a customer to validate that the hardware components of IHS 200 are the same hardware components that were installed at the factory during its manufacture, where such validations may be conducted using delta certificates that are generated in response to cryptographic events occurring in the administration of the IHS 200, such as due to adding new cryptographically attestable hardware components, or in making modifications to the cryptographic capabilities or characteristics of hardware components that are already installed in the IHS.

IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications. In some embodiments, each of the processors 205 may be uniquely identified based on a code or other identifier that may be permanently encoded in a respective processor 205 by its manufacturer. As described below, embodiments support validation of processors 205 as being the same processors that were installed at the factory during the manufacture of IHS 200. In some embodiments, the identity of processor(s) 205 may be validated based on attestations supported by an individual processor 205, such as a device identity certificate supported by a manufacturer of the processor.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b. The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory. In some embodiments, each of the memory modules 210a-n may be uniquely identified based on a code or other identifier that may be permanently encoded in a respective memory module 210a-n by its manufacturer. In some embodiments, memory modules 210a-n may be replaceable hardware components of IHS 200 and may each be identified based on attestations supported by an individual memory modules 210a-n, such as based on a device identity certificate that is generated and supported by a manufacturer of the memory modules. As described below, embodiments support validation of memory modules 210a-n as being the same memory modules that were installed at the factory during the manufacture of IHS 200. As described in additional detail below, embodiments may further support secure validation of the replacement, removal or addition of memory modules 210a-n.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources and/or other peripheral components.

As illustrated, IHS 200 may include one or more FPGA (Field-Programmable Gate Array) cards 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of such logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as in computing different operations that are being offloaded from processor 205. The FPGA card 220 may also include a management controller 220a that may support interoperation with the remote access controller 255 via a sideband device management bus 275a. In some embodiments, each of the FPGA cards 220 installed in IHS 200 may be uniquely identified based on a code or other identifier that may be permanently encoded in the FPGA card 220 by its manufacturer. In some embodiments, the identity of FPGA card 220 may be validated based on attestations supported by the FPGA card 220, such as a device identity certificate that is generated and supported by a manufacturer of the FPGA card 220. In some embodiments, FPGA card 220 may implement cryptographic capabilities that may occasionally be updated, thus altering the cryptographic characteristics of the FPGA card. As described below, embodiments support validation of FPGA card 220 as being the same FPGA card that was installed at the factory during the manufacture of IHS 200.

Processor(s) 205 may also be coupled to a network controller 225 via in-band bus 215, such as provided by a Network Interface Controller (NIC) that allows the IHS 200 to communicate via an external network, such as the Internet or a LAN. In some embodiments, network controller 225 may be a replaceable expansion card or adapter that is coupled to a motherboard connector of IHS 200. In some embodiments, network controller 225 may be an integrated component of IHS 200. In some embodiments, network controller 225 may be uniquely identified based on a code or other identifier, such as a MAC address, that may be permanently encoded in a non-volatile memory of network controller 225 by its manufacturer. In some embodiments, network controller 225 may be a replaceable hardware component of IHS 200, where the identity of the network controller may be validated based on attestations such as a device identity certificate supported by a manufacturer of the network controller. In some embodiments, network controller 225 may implement cryptographic capabilities that may occasionally be updated, thus altering the cryptographic characteristics of the network controller. As described below, embodiments support validation of network controller 225 as being the same network controller that was installed at the factory during the manufacture of IHS 200.

A variety of additional components may be coupled to processor(s) 205 via in-band bus 215. For instance, processor(s) 205 may also be coupled to a power management unit 260 that may interface with the power system unit 135 of the chassis 100 in which an IHS, such as a compute sled, may be installed. In certain embodiments, a graphics processor 235 may be comprised within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255. In some embodiments, components such as power management unit 260 and graphics processor 235 may also be uniquely identified based on a code or other identifier that may be permanently encoded in a non-volatile memory of these components by their respective manufacturer. In some embodiments, power management unit 260 and graphics processor 235 may each be identified based on attestations, such as a device identity certificate, supported by each component. As described below, embodiments support validation of these components as being components that were installed at the factory during the manufacture of IHS 200.

In certain embodiments, IHS 200 may operate using a BIOS (Basic Input/Output System) that may be stored in a non-volatile memory accessible by the processor(s) 205. The BIOS may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 255. As described in additional detail below, in some embodiments, BIOS may be configured to identify hardware components that are detected as being currently installed in IHS 200. In such instances, the BIOS may support queries that provide the described unique identifiers that have been associated with each of these detected hardware components by their respective manufacturers.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 200. These calculated hash values may then be compared against reference hash values that were previously stored in a secure non-volatile memory of the IHS, such as during factory provisioning of IHS 200. In this manner, a TPM may establish a root of trust that includes core components of IHS 200 that are validated as operating using instructions that originate from a trusted source.

As described, IHS 200 may include a remote access controller 255 that supports remote management of IHS 200 and of various internal components of IHS 200. In certain embodiments, remote access controller 255 may operate from a different power plane from the processors 205 and other components of IHS 200, thus allowing the remote access controller 255 to operate, and management tasks to proceed, while the processing cores of IHS 200 are powered off.

For instance, during such intervals where the processing cores of IHS 200 are powered off, remote access controller 255 may interface with the chassis management controller 125 of the chassis 100 in which IHS 200 is installed. For instance, remote access controller 255 may utilize out-of-band signaling pathways supported by chassis 100, such as via signaling pathways of a coupling supported by the connector used to attach IHS 200 to chassis 100, where out-of-band signaling may be implemented though connections separate from those supported by the backplane 160 of chassis 100, as illustrated in FIG. 1. In some embodiments, chassis management controller 125 may interfaces with remote access controller 255 in detecting cryptographic events occurring in the administration of IHS 200 and/or chassis 100.

As described, various functions provided by the BIOS, including launching the operating system of the IHS 200, may be implemented by the remote access controller 255. In some embodiments, the remote access controller 255 may perform various functions to verify the integrity of the IHS 200 and its hardware components prior to initialization of the operating system of IHS 200 (i.e., in a bare-metal state). In some embodiments, certain operations of the remote access controller 225, such as the described inventory certificate generation and validation operations, may operate using validated instructions, and thus within the root of trust of IHS 200.

In some embodiments, remote access controller 255 may be uniquely identified based on a code or other identifier that may be permanently encoded in a non-volatile memory of the remote access controller 255 by its manufacturer. As described below, embodiments support validation of remote access controller 255 as being the same controller that was installed at the factory during the manufacture of IHS 200. In some embodiments, remote access controller 255 may be identified based on attestations supported by the remote access controller 255, such as based on a device identity certificate.

Also as described below, during a provisioning phase of the factory assembly of IHS 200, a signed certificate that specifies factory installed hardware components of IHS 200 that were installed during manufacture of the IHS 200 may be stored in a non-volatile memory that is accessed by remote access controller 255. Using this signed inventory certificate stored by the remote access controller 255, a customer may validate that the detected hardware components of IHS 200 are the same hardware components that were installed at the factory during manufacture of IHS 200. As described in additional detail below, embodiments may further support secure validation of the replacement, removal or addition of hardware components of IHS 200 that are managed by remote access controller 255, or that are detected as hardware that is available for use by IHS 200, including shared hardware components 135, 145, 140, 150, 155, 130 of the chassis 100 in which the IHS 200 is installed.

In support of the capabilities for validating the detected hardware components of IHS 200 against the inventory information that is specified in a signed inventory certificate, remote access controller 255 may support various cryptographic capabilities. For instance, remote access controller 255 may include capabilities for key generation such that remote access controller may generate keypairs that include a public key and a corresponding private key. As described in additional detail below, using generated keypairs, remote access controller 255 may digitally sign inventory information collected during the factory assembly of IHS 200 such that the integrity of this signed inventory information may be validated at a later time using the public key by a customer that has purchased IHS 200. Using these cryptographic capabilities of the remote access controller, the factory installed inventory information that is included in an inventory certificate may be anchored to a specific remote access controller 255, since the keypair used to sign the inventory information is signed using the private key that is generated and maintained by the remote access controller 255.

In some embodiment, the cryptographic capabilities of remote access controller 255 may also include safeguards for encrypting any private keys that are generated by the remote access controller and further anchoring them to components within the root of trust of IHS 200. For instance, a remote access controller 255 may include capabilities for accessing hardware root key (HRK) capabilities of IHS 200, such as for encrypting the private key of the keypair generated by the remote access controller. In some embodiments, the HRK may include a root key that is programmed into a fuse bank, or other immutable memory such as one-time programmable registers, during factory provisioning of IHS 200. The root key may be provided by a factory certificate authority, such as described below. By encrypting a private key using the hardware root key of IHS 200, the hardware inventory information that is signed using this private key is further anchored to the root of trust of IHS 200. If a root of trust cannot be established through validation of the remote access controller cryptographic functions that are used to access the hardware root key, the private key used to sign inventory information cannot be retrieved. In some embodiments, the private key that is encrypted by the remote access controller using the HRK may be stored to a replay protected memory block (RPMB) that is accessed using security protocols that require all commands accessing the RPMB to be digitally signed using a symmetric key and that include a nonce or other such value that prevents use of commands in replay attacks. Stored to an RPMB, the encrypted private key can only be retrieved by a component within the root of trust of IHS 200, such as the remote access controller 255.

As described in additional detail below, the factory-provisioned inventory certificate of an IHS may be supplemented or replaced by a delta certificate that can be used in validating modifications to the factory-installed hardware of an IHS 200. In some embodiments, delta certificates for use in validating hardware modifications may be generated in response to cryptographic events that occur as a result of the administration of the IHS 200, such as in adding new hardware components or in making certain updates to cryptographic capabilities or characteristics of hardware components that are already installed in the IHS. In some embodiments, the management capabilities of remote access controller 255, such as monitoring procedures conducting using the sideband management connections 275a-d, may be utilized in detecting cryptographic events that trigger delta certificate generation.

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as non-standard hardware 220, network controller 225 and storage controller 230, are coupled to the IHS processor(s) 205 via an in-line bus 215, such as a PCIe root complex, that is separate from the I2C sideband bus connections 275a-d used for device management. The management functions of the remote access controller 255 may utilize information collected by various managed sensors 280 located within the IHS. For instance, temperature data collected by sensors 280 may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280. In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

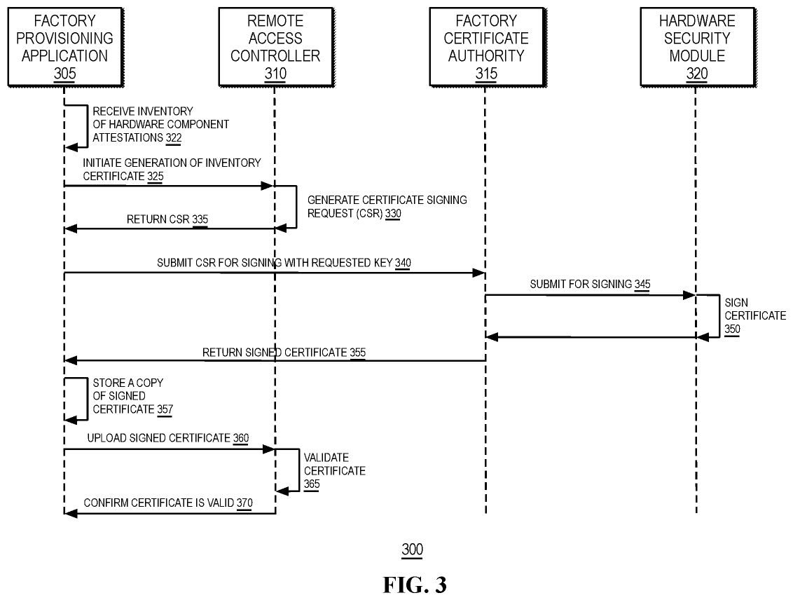

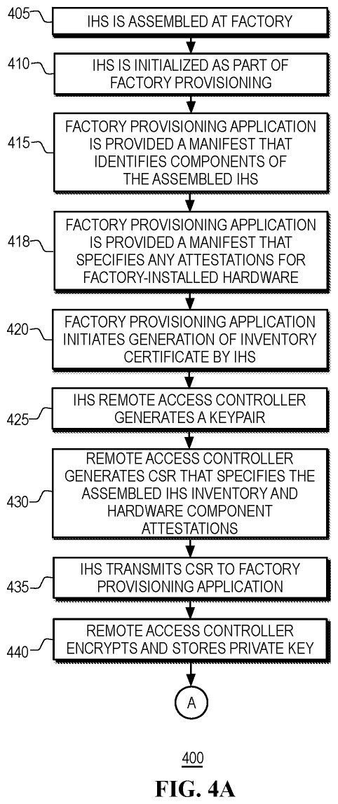

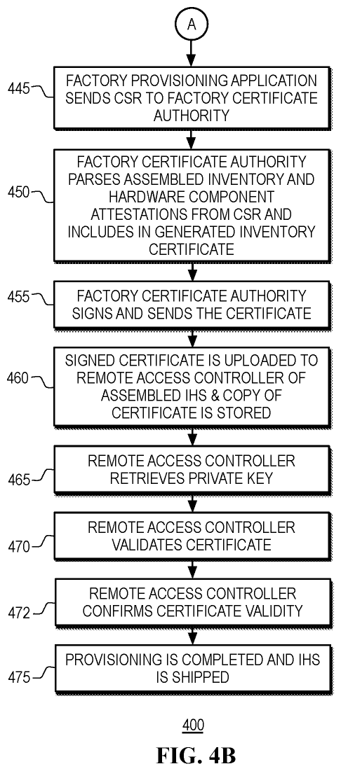

FIG. 3 is a swim lane diagram illustrating certain responsibilities of components of a system configured according to certain embodiments for factory provisioning of an IHS in a manner that supports event-based generation of delta certificates for validation of the IHS. FIGS. 4A-B are a flowchart describing certain steps of a method, according to some embodiments, for factory provisioning of an IHS in a manner that supports event-based generation of delta certificates for validation of the IHS. Some embodiments of the method of FIGS. 4A-B may begin, at block 405, with the factory assembly of an IHS, such as the assembly of a server described with regard to FIGS. 1 and 2. In some instances, an IHS may be manufactured using a factory process that includes multiple phases of assembly, validation and provisioning that must be completed before the IHS is supplied to a customer. As described, an IHS such as a server may be purpose-built for a particular customer such that the server is assembled and provisioned according to specifications provided by the customer. The initial factory assembly of such server IHSs may include the selection of a chassis and the fastening of various hardware components to the selected chassis. Such a factory assembly process may include generating a manifest that tracks the individual hardware components that are installed in an IHS or chassis. As described above, the installed hardware components may include standard components and may also include specialized components that have been requested by a specific customer that has contracted for the assembly and delivery of an IHS that is installed in a chassis.

Once the assembly of an IHS has been completed and installed in a chassis, the IHS may be subjected to manual and automated inspections that confirm the IHS has been properly assembled and does not include any defects. After confirming an IHS has been assembled without any manufacturing defects, at block 410, factory provisioning of the IHS may be initiated. In some instances, the provisioning of an IHS at the factory may include various stages that may include stages for loading of firmware, configuring hardware components, and installing an operating system and other software. As indicated in FIG. 3, various aspects of this factory provisioning process may be conducted using a factory provisioning application 305, where this factory provisioning application may run on one or more servers and may interface with an IHS that is being provisioned once a requisite amount of firmware and software has been installed to the IHS.

As described, a manifest of the individual hardware components that are installed in an IHS may be generated during assembly of the IHS. Such a manifest may be a file that includes an entry for each component installed to an IHS, where the entry may specify various characteristics of the component, such as model numbers and installation locations, and may also specify any unique identifiers associated with the component, such as a MAC address or a serial number. At block 415, a manifest generated during assembly of an IHS is provided to the factory provisioning application 305 that is being used to provision the assembled IHS.

As indicated in FIG. 3, at 322 and at 418, the factory provisioning application 305 also receives a manifest of any available attestations for individual factory-installed hardware components of the IHS that is being provisioned. In some instances, this manifest of hardware component attestations may be generated by interrogating individual factory-installed hardware component, such as by retrieving data encoded in a memory, register or other location of the hardware component, where this data is made available by the hardware component in support of identifying the component and providing characteristics of the component for use in its management. As described above, remote access controller 310 may include various sideband signaling pathways with individual managed hardware components of an IHS. In embodiments, such sideband signaling may be used to identify attestations supported by each of the factory-installed hardware components. For instance, queries made using the sideband signaling pathways of remote access controller 310 may be used to determine whether a hardware component supports SPDM attestation and/or whether the hardware component has its own identity certificate that can be used in validating the authenticity of the hardware component.

Based on the manifest of factory-installed hardware and of available attestations for any of the individual factory-installed hardware components, at block 420, the factory provisioning application 305 may also initiate the generation of an inventory certificate that may be used to validate that the detected hardware components of the IHS are the same hardware components that were installed during the factory assembly of the IHS. The validation of the IHS hardware as factory installed using the inventory certification may be extended through the use of a delta certificates. In embodiments, such delta certificates may be generated in response to the detection of cryptographic events occurring in the administration of the IHS, such as in adding new hardware components or in making updates to cryptographic capabilities or properties of hardware components that are installed in the IHS.

As described with regard to FIGS. 1 and 2, an IHS may include a remote access controller that provides capabilities for remote management of an IHS, where these remote management capabilities may include sideband management of various hardware components of an IHS, and sideband communications with a chassis management controller of the chassis in which the IHS is installed. As indicated in FIG. 3, the generation of an inventory certificate for a newly assembled IHS, at 325, may be initiated via a request from the factory provisioning application 305 to the remote access controller 310 of the IHS. As described with regard to FIG. 2, a remote access controller of an IHS may include cryptographic capabilities that operate within the root of trust of the IHS and that include the ability to generate cryptographic keypairs. Utilizing such cryptographic capabilities, at block 425, the remote access controller 310 initiates the generation of an inventory certificate by generating a cryptographic key pair for use in validating the authenticity of inventory information that is included in an inventory certificate.

At block 430 and at 330, the remote access controller 310 generates a certificate signing request (CSR) for a digital identity certificate, where the request specifies the public key of the key pair generated by the remote access controller and also specifies the factory installed hardware inventory from the manifest that was generated during assembly of the IHS, and also specifies the inventory of available attestations for any of the individual factory-installed hardware components. The factory installed hardware and shared hardware inventory information included in the CSR may be signed by the remote access controller using the private key from the generated keypair. At block 435 and at 335, the CSR for the requested inventory certificate is transmitted to the factory provisioning application 305 by the remote access controller 310. At block 440, the remote access controller safeguards the private key from the generated key pair. In some embodiments, the remote access controller may encrypt the private key using the hardware root key (HRK) of the IHS and may store the encrypted key to a protected memory, such as the replay protected memory block that is described with regard to FIG. 2.

Upon receiving the certificate signing request from the remote access controller 310, at block 445 and at 340, the factory provisioning application 305 submits the CSR for signing by a factory certificate authority 315. In some embodiments, the factory provisioning application 305 specifies a factory key to be used by the factory certificate authority 315 in signing the inventory certificate. For instance, the factory provisioning application may include the name of a trusted certificate associated with a factory key as an attribute of the CSR that is transmitted to the factory certificate authority 315. Upon receipt of the CSR, at block 450, the factory certificate authority parses from the CSR: the hardware inventory information, available attestations for any of the individual factory-installed hardware components, the public key generated by the remote access controller and the information specifying the requested signing key. Based on the information parsed from the CSR, the factory certificate authority generates a digital identity certificate, referred to herein as an inventory certificate, that is associated with the public key provided by the remote access controller and that specifies the factory installed hardware inventory of the IHS, and also available attestations for any of individual factory-installed hardware components.

As indicated in FIG. 3, at 345, the factory certificate authority 315 submits the generated inventory certificate for signing by a hardware security module 320 that may be a dedicated hardware component of a factory provisioning server that safeguards cryptographic keys and implements cryptographic functions utilized in the factory provisioning process. In some embodiments, the factory certificate authority 315 may also specify a certificate name associated with a signing key that is maintained by the hardware security module 320. At 350, the hardware security module 320 utilizes the private key associated with the specified certificate in order to digitally sign the submitted inventory certificate, which includes the inventory of the factory installed hardware components of the IHS and available attestations for any of the individual factory-installed hardware components. The signed inventory certificate is then returned to the factory certificate authority 315 by the hardware security module 320.

Once the inventory certificate has been signed, at block 460 and at 355, the signed inventory certificate is transmitted from the factory certificate authority 315 to the factory provisioning application 305. As indicated in FIG. 3 at 357, the factory provisioning application 305 may store a copy of the signed inventory certificate. In some instances, the copy may be saved to a data store utilized in providing ongoing support of the IHS once it has been shipped and has been deployed by a customer. Once the IHS is deployed, embodiments may augment this factory-provisioned inventory certificate with one or more delta certificates that each specify modifications to the hardware of the IHS, such as adding, removing or replacing a hardware components of the IHS. In embodiments, such delta certificates may be generated in response to cryptographic events occurring in the administration of the IHS.

At block 465 and at 360, the signed inventory certificate is than loaded to the assembled IHS. As indicated in FIG. 3, in some embodiments, the signed inventory certificate may be uploaded to a remote access controller 310 of the assembled IHS, such that the signed inventory certificate may be stored to a nonvolatile memory or other persistent storage that is accessible by the remote access controller 310 independent from the operating system of the IHS. In other embodiments, the signed inventory certificate may be uploaded without reliance on the remote access controller to another non-volatile memory of the IHS.

Some embodiments may continue, at 365, with the validation of the signed inventory certificate by the remote access controller 310. Using the private key from the generated keypair, at block 470, the remote access controller decrypts the signature included by the remote access controller in the CSR and confirms that the inventory information included in the signed inventory certificate matches the inventory information that was submitted in the certificate signing request, thus validating the integrity of the generation of the signed inventory certificate. At block 472, the remote access controller confirms that the inventory included in the signed inventory certificate is valid and, at 370, the remote access controller 310 confirms the validity of the inventory certificate with a notification to the factory provisioning application 305. With the generation and validation of the signed inventory certificate completed, additional factory provisioning of the assembled IHS may be completed and, at block 490, the assembled IHS may be shipped from the factory to an individual or location designated by a customer.

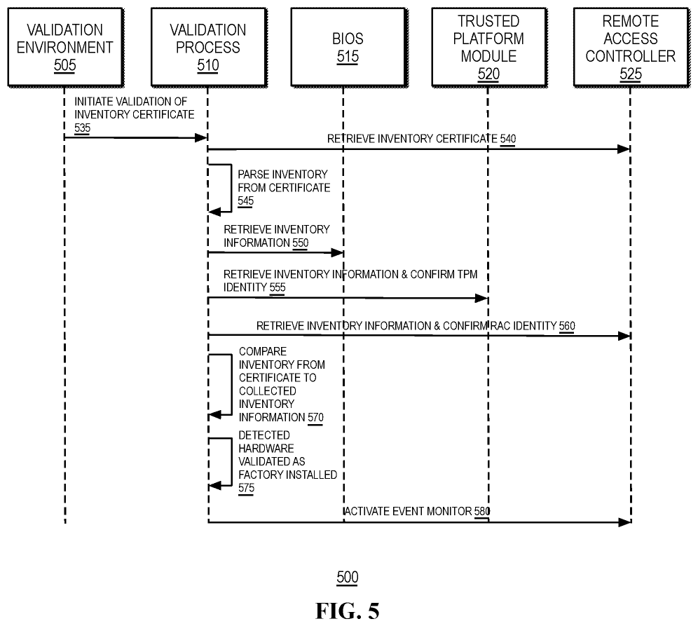

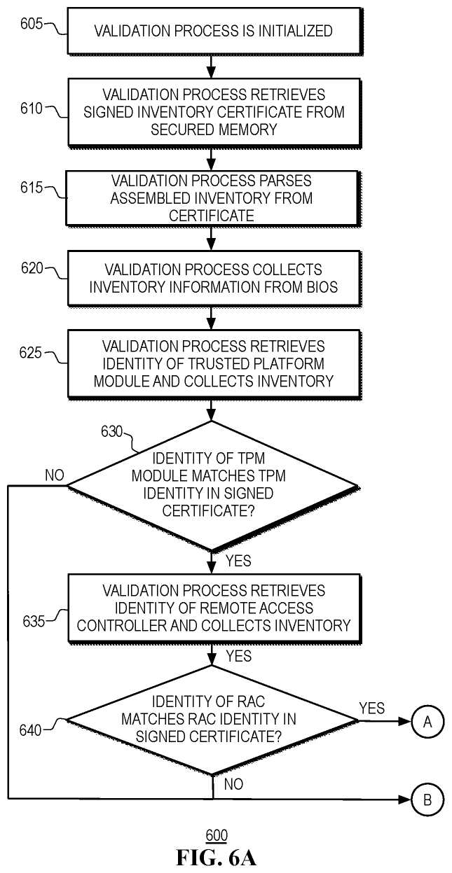

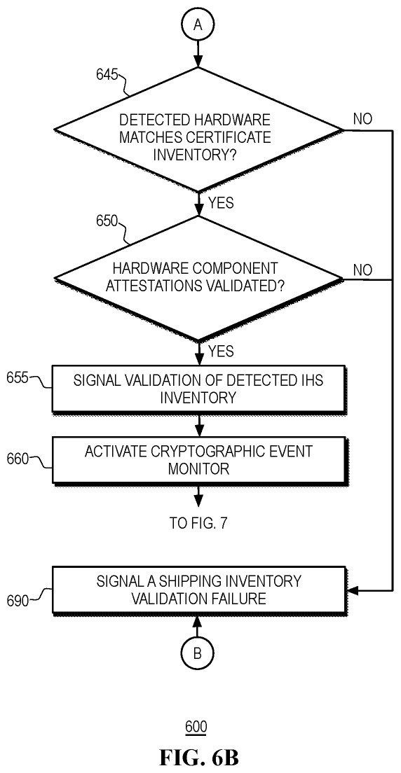

FIG. 5 is a swim lane diagram illustrating certain responsibilities of components of an IHS configured according to certain embodiments for use of an inventory certificate in the validation of the hardware components of the IHS, including the event-based generation of delta certificates for validation of modifications to the hardware components of the IHS. FIG. 6 is a flowchart describing certain steps of a method, according to some embodiments, for use of an inventory certificate in the validation of the hardware components of the IHS, including the event-based generation of delta certificates for validation of modifications to the hardware components of the IHS. Embodiments may begin with the delivery of an IHS to a location specified by a customer, where the IHS has been assembled and provisioned according to the procedures set forth above. In particular, the delivered IHS has been provisioned at the factory to include a signed inventory certificate that specifies the factory installed hardware components of the IHS, and that specifies available attestations for any of the individual factory-installed hardware components.

Upon receiving an IHS configured in this manner, the IHS may be unpacked, assembled and initialized by an administrator. In some instances, an IHS may be ready for immediate deployment by a customer. In other instances, an IHS may require further provisioning by customer before it is deployed, such as for operation within a particular data center. As such, in various instances, an IHS may be unpacked, assembled and initialized in order to deploy the IHS or to prepare it for further provisioning.

At block 605, the IHS has been powered and validation process is initialized. In some instances, the validation process may be initialized as part of the initial provisioning of an IHS by a customer. In other instances, the validation process may be initialized by an administrator as part of an onboarding procedure for configuring modifications to the hardware of the IHS. In some embodiments, the validation process may run within a pre-boot environment, such as a PXE (Preboot eXecution Environment) operating environment. In some embodiments, a PXE operating environment in which a validation process runs may be retrieved from a network location and may thus be executed using the processing and memory capabilities of the IHS. In some embodiments, a PXE operating environment may be retrieved using secure protocols, such as HTTPS, in order to assure the integrity of the operating environment instructions that are utilized. In some embodiments, a pre-boot operating environment in which the validation process runs may include an operating environment that is executed by the remote access controller of the IHS based on validated firmware instructions. In these embodiments that utilize a pre-boot operating environment, the validation of the detected hardware components of the IHS is conducted prior to booting of the operating system of the IHS.

In some embodiments, the validation process may run as part of a diagnostic mode that is supported by an IHS. For instance, an IHS may support a diagnostic mode that may be initiated by a user or may be initiated automatically in response to detecting various conditions, where the diagnostic mode may support various diagnostic tools, including the described hardware validation procedures. In some embodiments, the diagnostic mode may involve re-booting the IHS to a diagnostic environment, while other embodiments may support diagnostic mode operations that run within the operating system of the IHS. Accordingly, some embodiments may support the described hardware validation procedures as a feature available within the operating system of the IHS. In such embodiments, the operating system may be configured to periodically conduct the described hardware validation procedures, such as on a daily or weekly basis. The operating system may likewise be configured to conduct the hardware validation procedures in response to a detected security notification, such as a notification that a process is attempting to access a protected resource. In some embodiments, the described validation procedures may be implemented remotely, such as via the described HTTPS protocols, where the remote validation procedures may rely both on information retrieved from the IHS via HTTPS and on remote information, such as information maintained by the manufacturer of the IHS or by an entity supporting the administration of the IHS.

As indicated at 535 of FIG. 5, an inventory certificate validation process 510 is initiated within a validation environment 505 that may include a pre-boot environment, a diagnostic environment or other environment supporting the validation process. In some embodiments, the inventory certificate validation process 510 operates based on validated instructions, such as based on instructions that, when used to calculate a hash value, are confirmed to correspond to a value stored in an immutable memory of the IHS during its factory provisioning. In this manner, the inventory certificate validation process 510 may be added to the root of trust of the IHS. At block 610 and as indicated at 540, the inventory certificate validation process 510 retrieves the signed inventory certificate from the remote access controller 525, or from a persistent memory of the IHS. As described above, the factory provisioning process may include uploading a signed original inventory certificate to the remote access controller or to a persistent memory of the IHS. At block 615 and at 545, the inventory certificate validation process 510 parses the hardware inventory information from the signed inventory certificate, including the inventory of shared chassis hardware accessible by the IHS. Using the public key provided in the signed inventory certificate, the inventory validation process 510 may confirm the integrity of the inventory information that is included in the signed inventory certificate.

In some scenarios, the inventory certificate validation process 510 may commence by collecting an inventory of the hardware components that are detected by the IHS, where this detected hardware may include shared hardware of the chassis in which the IHS is installed. In some instances, this collection of inventory information may be initiated earlier by the inventory certificate validation process, such as during initialization of the IHS. At block 620 and as indicated at 550, the inventory certificate validation process 510 may query the BIOS 515 of the IHS for an inventory of hardware components that have been detected by BIOS 515. At block 625 and as indicated at 555, the inventory certificate validation process 510 may retrieve additional hardware inventory information from a Trusted Platform Module (TPM) 520 of the IHS. In some instances, the TPM 520 may identify hardware components that are also identified by BIOS 515. However, in some instances, the TPM 520 may identify certain hardware components, such as secure memory modules, that are not identified by BIOS 515.

As described with regard to FIG. 2, a Trusted Platform Module may serve to establish an initial hardware root of trust in an IHS such that the hardware components within this root of trust operate using validated software instructions. Accordingly, in some embodiments, the inventory certificate validation process 510 may compare identity information for the detected TPM 520 against the TPM identity information that is parsed from the inventory certificate at block 545. In some instances, the detection of any discrepancies between the identity of the TPM specified in the inventory certificate and the identity reported by TPM 520 may result in terminating any further validation procedures.

At block 630, the validation process may confirm the identity of the detected TPM against the identity of the TPM reported in the signed inventory certificate. If the identity of the TPM is successfully validated, validation may continue at block 635. However, if the identity of the TPM is not validated, at block 690, the validation process may signal a core inventory validation failure since any discrepancies between the identity of the factory installed TPM and the TPM that has been detected signals a potential compromise in the root of trusted hardware components of the IHS.

At block 635 and as indicated at 560, the inventory certificate validation process 510 may retrieve additional hardware inventory and thermal information from a remote access controller 525 of the IHS. As with TPM 520, remote access controller 525 may provide redundant identification of some hardware components and may provide exclusive identification of other hardware components, such as internal memories, management controllers or logic units utilized by the remote access controller 525.

As with TPM 520, in some embodiments, the inventory certificate validation process 510 may compare identity information for the detected remote access controller 525 against the remote access controller identity information that is parsed from the inventory certificate at block 545. In some instances, the detection of any discrepancies between the identity of the remote access controller specified in inventory certificate and the identity reported by remote access controller 525 may also result in terminating any further validation procedures.

At block 640, the validation process 510 may confirm the identity of the detected remote access controller against the identity of the remote access controller reported in the signed inventory certificate. If the remote access controller is successfully validated, validation may continue at block 645. Otherwise, if the identity of the remote access controller is not validated, at block 690, the inventory certificate validation process may signal a core inventory validation failure. As with the TPM, any discrepancies between the identity of the factory installed remote access controller and the remote access controller detected in the initialized IHS signals a potential compromise of the root of trust of the IHS.

The inventory certificate validation process 510 may retrieve additional inventory from any other available data sources, such as directly from the processor of the IHS or from a chassis management controller of a chassis in which the IHS has been installed. Upon completion of the collection of the detected hardware components of the initialized IHS, at block 570, the inventory certificate validation process compares the collected inventory information of the detected components against the inventory information that is parsed from the signed inventory certificate. In some instances, the validation of an individual hardware component may be based on the unique identifiers included in the inventory certificate, such as based on a MAC address. The authenticity of the unique identifier information included in the inventory certificate may be validated using the corresponding digital signature that is included in the inventory certificate.

In some embodiments, identification of a detected component as a factory-installed component specified in the inventory certificate may be conducted based on matching of these unique identifiers of the detected component and of the inventory certificate. At 645, the validation process 510 matches unique identifiers collected from each of the detected hardware of the IHS against the identifiers specified in the inventory certificate. As described, in some embodiments, some of the hardware components of the IHS may include their own forms of attestation, such as a device identity certificate that was generated by the manufacturer of the hardware component. Such a device identity certificate may include information for identifying a hardware component, where the validity of the device identity certificate may be validated through challenges issued to the certificate authority used to sign the certificate, such as the certificate authority of the manufacturer of the hardware component.

Using any available device identity certificates, at 650, the validation process 510 uses these available certificates to confirm the validity of detected components. In particular, the validation process 510 evaluates each of the device identity certificates that are included in the inventory certificate. The validation process 510 may validate the authenticity of the device identity certificate and use the identification information from the certificate to confirm the authenticity of a detected hardware component. As indicated in FIG. 6, if any of the detected hardware components is not validated based on an entry from the inventory certificate, whether the validation attempts are based on unique identifiers and/or based on any available device attestations, at 690, embodiments signal a validation failure based on the inability to authenticate a detected device. Similarly, embodiments signal a validation failure when a hardware component specified in the identity certificate, whether identified by a unique identifiers or a device attestation, is not detected by the IHS. In such instances, the signaled validation failures specifies the missing hardware component that was not detected.

If no discrepancies are identified and information collected from each the detected hardware components matches identifiers or device attestations from the factory-provisioned inventory certificate, at block 655, the validation process 510 signals a successful validation of the detected hardware of the IHS as being factory-installed hardware. Based on the notification, a customer receiving delivery of the IHS or an administrator is thus assured that the IHS is operating using only hardware components that were installed at the factory during manufacture of the IHS, with no missing or additional hardware components detected.

As indicated in FIGS. 5 and 6B, at 580 and at 660, the validation process 510 notifies the remote access controller 525 of the successful validation of the hardware components that were detected by the IHS in order to activate a cryptographic event monitor by the remote access controller 525. As described in additional detail below, the remote access controller 525 may be used to implement a cryptographic event monitor that detects modifications to the cryptographic credentials or capabilities of a hardware component of the IHS. Due to such modifications, these hardware components of the IHS may no longer be valid with respect to the factory-provisioned inventory certificate.

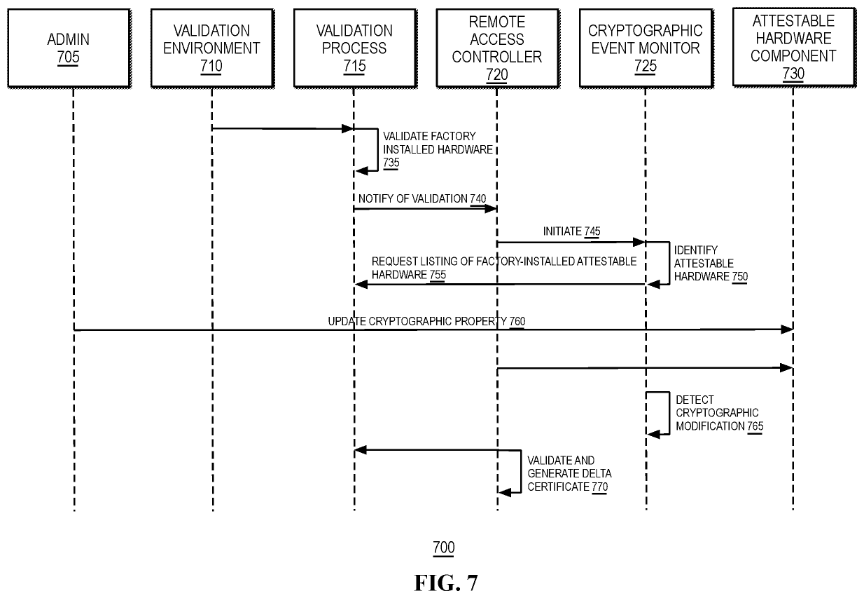

FIG. 7 is a swim lane diagram illustrating certain responsibilities of components of a system configured according to certain embodiments for event-based generation of delta certificates for validation of the hardware of an IHS. Embodiments illustrated in FIG. 7 begin with the validation of the hardware components that are detected by an IHS, such as IHS 200 of FIG. 2. Accordingly, embodiments may begin with the retrieval of the factory-provisioned inventory certificate by the validation process 715 that is launched in a validation environment 710, as described above, where the inventory certificate may be retrieved from its factory provisioned location by the remote access controller 720 of the IHS. As described above, the retrieval of the factory-provisioned inventory certificate and its use in validating the hardware detected may be initiated in a variety of scenarios, such as upon rebooting an IHS.

At 735, the retrieved inventory certificate is used in the successful initial validation of the detected hardware of the IHS as including only factory-installed hardware. As described, this initial validation may occur upon an IHS that is factory-provisioned with an inventory certificate being received at a datacenter or other customer location and initialized for the first time by an administrator that is preparing the IHS for deployment. As described above and as indicated in FIG. 7, at 740, the validation process 715 notifies the remote access controller 720 of the successful validation of the hardware detected by the IHS.

In certain embodiments, this initial validation of the hardware of the IHS as factory-installed is required in order for the capabilities of the remote access controller 720 to be enabled with respect to the operation of the cryptographic event monitor 725. Once the initial hardware validation of the IHS has been reported, the capabilities of the remote access controller 720 may then be used in interfacing with managed hardware of the IHS in order to detect events that alter that alter the cryptographic capabilities or credentials. The cryptographic event monitor 725 is thus operable, only after establishing that the IHS has been received and initialized using only the factory-installed hardware.

Upon this initial validation of the detected hardware of an IHS, at 745, the remote access controller 720 initiates the cryptographic event monitor 725. As described with regard to FIG. 2, a remote access controller 720 may operate a secure execution environment in which management processes may operate, in some embodiments in a separate power plane from the main processors of the IHS and with separate network access that can be used to interface with remote management tools. The secure execution environment of the remote access controller 720 may be used to operate a variety of management programs. As described, such programs may operate using factory-provisioned and validated instructions such that the remote access controller 720 operates within the root of trusted hardware of an IHS.

Within this secure execution environment, the remote access controller 720 initiates a cryptographic event monitor 725 that is configured to detect events that indicate a change to the cryptographic properties or capabilities of an installed hardware component. As described, the hardware of an IHS that operates in a datacenter may include various types of replaceable hardware components, such as storage drives 240a-n that may be regularly added and removed from an IHS, and may be regularly swapped between different IHS. For instance, a computing cluster formed from multiple IHSs may utilize a shared pool of storage drives that have been approved for use in the cluster and may thus be regularly moved between the IHS used to implement the cluster. In addition, various updates may be made to installed components, where some updates may modify the cryptographic information used to validate the component. Accordingly, cryptographic events detected by the cryptographic event monitor 725 may include, for instance, the addition or removal of replaceable hardware components, and updates to the cryptographic properties and capabilities of an already installed hardware component.

As indicated in FIG. 7, the first operation of the cryptographic event monitor 725 may be to identify the validated hardware of the IHS that are attestable hardware components 730, such as SPDM compliant hardware components that are provided with their own device identity certificate. In some embodiments, the remote access controller 720 may have knowledge of some or all of the cryptographic properties and capabilities of the hardware installed in an IHS. For instance, for some managed hardware components of the IHS, the remote access controller 720 may have access to management tools that indicate where specific hardware components are SPDM compliant, or that indicate that the hardware component has attestation capabilities that can be enabled.

In the illustrated embodiment, at 755, the cryptographic event monitor 725 queries the validation process 715 for a complete listing of the installed hardware of the IHS that is cryptographically attestable. As described, attestations credentials that are available for validating each factory-installed hardware component may be specified in the inventory certificate of an IHS. In some embodiments, the validation process 715 may determine the hardware components that are cryptographically attestable based on this identity certificate information and may supply the cryptographic event monitor 725 with a listing of these components. In some embodiments, the validation process 715 may supplement or update this identity certificate information that is provided to the cryptographic event monitor 725 with information for identifying the attestation credentials currently used in validating each of the cryptographically attestable hardware components. The validation process 715 may also provide the cryptographic event monitor 725 with information specifying any configurable cryptographic capabilities of a hardware component that are being used in validating the component, such as the enabled used of a device identity certificate provided by the component.

The cryptographic event monitor 725 receives the listing of attestable hardware components 730, and any additional information provided by the validation process 715, and incorporates the received information into its monitoring for cryptographic events. For instance, the cryptographic event monitor 725 may iterate through the listing of attestable hardware components 730 in order to confirm their cryptographic capabilities have not been modified. The IHS may operate in this manner for any interval before an administrator makes modifications to the hardware of the IHS, or to the hardware capabilities of the IHS. Various different modifications that alter the cryptographic properties or capabilities may be detected, at 765, by the cryptographic event monitor 725.

In one illustrative scenario, the cryptographic event monitor 725 may detect the installation of new hardware to the IHS, where this new hardware has its own attestation credentials, such as a device identity certificate. Until these attestation credentials of the new hardware component has been incorporated into a delta certificate, the validation process 715 is unable to incorporate validation of this new component into its validation of the detected hardware as either factory-installed, or an authorized modification to the factory-installed hardware. In some embodiments, the cryptographic event monitor 725 may detect the installation of a new hardware component based on notifications issued by various management interfaces supported by the remote access controller 720. Once notified of a new component, the remote access controller 720 may interrogate the component, such as via the described sideband management interfaces, in order to determine whether the component has its own attestation credentials. For instance, an SPDM (Security Protocol and Data Model) compliant attestable hardware component 730 supports queries by which the component specifies it is attestable via SPDM and it has its own device identity certificate.

The cryptographic event monitor 725 may also be configured to detect updates to the attestations that are supported by an installed hardware component. For instance, a device identity certificate for an installed hardware component may be replaced, such as due to the certificate authority that issued the certificate being compromised. In another illustrative scenario, the device identity certificate of a hardware component may be replaced to reflect a change in entities that is providing support for the hardware component and that vouches for its authenticity through the identity certificate. For instance, a network controller installed in the IHS may be manufactory and provisioned with a device identity certificate. This device identity certificate is identified during factory-provisioning and specified in the inventory certificate as a capability for attesting to the authenticity of the network controller.

This device identity certificate may be updated, however, in response to a change in ownership of the company the manufactured the network controller, or in response to a new entity taking over the ongoing support for this network controller. In such instances, the cryptographic event monitor 725 detects changes to the attestation credentials of an installed hardware component. For instance, the sideband management interfaces supported by remote access controller 720 may be monitored for SPDM commands issued to the managed hardware components of the IHS. In particular, these sideband management connections may be monitored for commands used to update the component's attestation credentials, such as its identity certificate.

The cryptographic event monitor 725 may also be configured to detect updates to the cryptographic capabilities of installed hardware components of an IHS. As described, some hardware components may include their own device identity certificates for use in validating the authenticity of the component. For some hardware, the ability to utilize this device identity certificate may be enabled or disabled. For instance, a firmware update to an installed hardware component may serve to enable or disable its attestation capabilities, such as disabling use of the device identity certificate due to the certificate being revoked. In such instances, validation of the installed hardware component may still be possible, but not using these device attestations. However, the validation process 715 is unable to validate the component using the modified cryptographic capabilities until a delta certificate is created for validating this modification.

Accordingly, in response to the detection of cryptographic event, at 770, the remote access controller 720 is tasked with generating a delta certificate for use in validating an attestable hardware component 730 of the IHS, but now using the updated cryptographic properties and capabilities that have been detected. In some instances, the cryptographic event monitor 725 may issue a prompt or other notification to administrators when a cryptographic event has been detected with respect to an attestable hardware component 730, and a delta certificate will be required in order to validate that component. Such a prompt may allow administrators to confirm the cryptographic event that was detected by the cryptographic event monitor 725, such as to confirm the addition of new attestable hardware or an update to the firmware of an attestable hardware component.

In some embodiments, the cryptographic capabilities of a remote access controller, such as described with regard to FIG. 2, may include capabilities for generating cryptographic identity certificates, such that remote access controller 720 may be configured generate delta certificates upon receiving a request from the cryptographic event monitor 725, where each delta certificate supports validation of an attestable hardware component 730 using updated cryptographic properties or capabilities of the component. In some embodiments, the remote access controller 720 may request the generation of delta certificates from a certificate authority that may be the same as or related to the factory certificate authority 315 utilized in the generation of the factory-provisioned inventory certificates. In other embodiments, the remote access controller 720 may rely on another trusted certificate authority for generation of delta certificates.

In the delta certificates, the remote access controller 720 may include the updated cryptographic properties or capabilities that have been detected. For instance, the delta certificate may specify an updated device identity certificate for use in validating an attestable hardware component 730. In another example, the delta certificate may specify an updated validation capability of an attestable hardware components 730, such as enablement or disablement of cryptographic identification by the component that may result from a firmware update.

As with the original inventory certificates, the remote access controller 720 may store the generated delta certificate to a protected memory device or other protected persistent data storage. In embodiments where a delta certificate is not generated directly by the IHS, the remote access controller 720 may validate received delta certificates, such as through confirmation that the delta certificate has been derived from the factory-provisioned inventory certificate maintained by the remote access controller, and such as through challenges issued to the certificate authority that generated the delta certificates.

With the delta certificate generated and stored for use by the IHSs reporting discrepancies, an administrator may be notified that the cryptographic event has been detected and that a delta certificate for validating a hardware component using updated cryptographic properties and/or capabilities of the component has been generated and stored. Going forward, validation of the hardware detected by the IHS may proceed according to the procedures of FIGS. 5 and 6, with any identified discrepancies from the factory-installed inventory evaluated for authenticity using the stored original inventory certificate and using the generated delta certificate, which specifies the updated cryptographic properties and capabilities to be used in validating the hardware component.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A system comprising:
an IHS (Information Handling System) comprising:
one or more processors;
one or more memory devices coupled to the processors, the memory devices storing computer-readable instructions that, upon execution by the processors, cause a validation process of the IHS to:
validate hardware detected by the IHS as factory-installed based on an inventory specified in a first factory-provisioned inventory certificate; and
notify a remote access controller when the hardware detected by the IHS is validated as factory-installed based on the inventory certificate; and
the remote access controller comprising one or more logic units and further comprising one or more memory devices storing computer-readable instructions that, upon execution by the logic units, cause the remote access controller to:
based on the notification of validated hardware from the IHS, initiate monitoring for cryptographic events related to the validated hardware; and
when a cryptographic event is detected, generate a delta certificate for validating a first of the factory-installed hardware components of the IHS using updated cryptographic information from the detected cryptographic event.

2. The system of claim 1, wherein the cryptographic event comprises an update to a cryptographic attestation for the first of the factory-installed hardware components.

3. The system of claim 2, wherein the cryptographic event comprises an update to a device identity certificate of the first of the factory-installed hardware components.

4. The system of claim 1, wherein the cryptographic event comprises installation of an unrecognized hardware component to the IHS, where the unrecognized hardware component comprises a device identity certificate.

5. The system of claim 1, wherein the cryptographic event comprises an update to firmware used by the first of the factory-installed hardware components.

6. The system of claim 5, wherein the update to the firmware enables a cryptographic capability of the first of the factory-installed hardware components.

7. The system of claim 6, wherein the enabled cryptographic capability comprises enabling use of a device identity certificate.

8. The system of claim 1, wherein the factory-provisioned inventory certificate is stored to a persistent memory of the IHS during the factory-provisioning of the IHS.

9. The system of claim 8, wherein the delta certificate is stored to the persistent memory of the IHS.

10. The system of claim 1, wherein the monitoring for cryptographic events is not initiated by the remote access controller until receiving the notification that the hardware detected by the IHS is validated as factory-installed.

11. A method for validating modifications to hardware of an IHS (Information Handling System), the method comprising:
validating, by a pre-boot validation process of the IHS, hardware detected by the IHS as factory-installed based on an inventory specified in a first factory-provisioned inventory certificate;
notifying a remote access controller of the IHS when the hardware detected by the IHS is validated as factory-installed based on the inventory certificate;
based on the notification of validated hardware from the IHS, initiating, by the remote access controller, monitoring for cryptographic events related to the validated hardware;
detecting a cryptographic event that modifies cryptographic properties or capabilities of a first of the factory-installed hardware components of the IHS; and
when the cryptographic event is detected, generating a delta certificate for validating the first of the factory-installed hardware components of the IHS using updated cryptographic information from the detected cryptographic event.

12. The method of claim 11, wherein the cryptographic event comprises an update to a cryptographic attestation for the first of the factory-installed hardware components.

13. The method of claim 12, wherein the cryptographic event comprises an update to a device identity certificate of the first of the factory-installed hardware components.

14. The method of claim 11, wherein the cryptographic event comprises installation of an unrecognized hardware component to the IHS, where the unrecognized hardware component comprises a device identity certificate.

15. The method of claim 11, wherein the cryptographic event comprises an update to firmware used by the first of the factory-installed hardware components.

16. The method of claim 15, wherein the update to the firmware enables a cryptographic capability of the first of the factory-installed hardware components.

17. The method of claim 11, wherein the factory-provisioned inventory certificate is stored to a persistent memory of the IHS during the factory-provisioning of the IHS.

18. A remote access controller installed in an IHS (Information Handling System) comprising one or more logic units and further comprising one or more memory devices storing computer-readable instructions that, upon execution by the logic units, cause the remote access controller to:
initiate by a pre-boot validation process;
validate hardware detected by the IHS as factory-installed based on an inventory specified in a first factory-provisioned inventory certificate;
based on the validation of the hardware detected by the IHS, initiate monitoring for cryptographic events related to the validated hardware; and
when a cryptographic event is detected, generate a delta certificate for validating a first of the factory-installed hardware components of the IHS using updated cryptographic information from the detected cryptographic event.

19. The remote access controller of claim 18, wherein the cryptographic event comprises an update to a device identity certificate of the first of the factory-installed hardware components.

20. The remote access controller of claim 18, wherein the cryptographic event comprises an update to firmware used by the first of the factory-installed hardware components.
